(19) United States
(12) Patent Application Publication
(10) Pub. No.: US 2017/0308800 A1
(43) Pub. Date: Oct. 26, 2017

(54) Interchangeable Artificial Intelligence Perception Systems and Methods

(71) Applicant: Smokescreen Intelligence, LLC, Kansas City, MO (US)

(72) Inventors: Chris CICHON, Kansas City, MO (US); Isaiah BLACKBURN, Kansas City, MO (US); Casey ADAMS, Kansas City, MO (US)

(73) Assignee: Smokescreen Intelligence, LLC, Kansas City, MO (US)

(21) Appl. No.: 15/496,179

(22) Filed: Apr. 25, 2017

Related U.S. Application Data
(60) Provisional application No. 62/327,643, filed on Apr. 26, 2016.

(51) Int. Cl. G06N 5/04; G06T 11/60; G06N 99/00

(52) U.S. Cl. CPC G06N 5/04; G06N 99/005; G06T 11/60

(57) ABSTRACT

An artificial intelligence (AI) combination platform or orchestration module is described that orchestrates and automates the processes of selecting, building, testing, and delivering new or integrated computer vision, detection, sensor and perception algorithms that can be published or leveraged in near real time by sensors, hardware or applications. The AI combination platform includes one or more of the following engines: algorithm mixer engine, retrospective search engine, algorithm recommendation engine, quality assurance engine, certification engine, and perception engine.

### CROSS REFERENCE TO RELATED APPLICATIONS

This application claims the benefit of U.S. Provisional Patent Application No. 62/327,643, filed on Apr. 26, 2016, titled “Interchangeable Artificial Intelligence Perception Systems and Methods,” which is hereby incorporated by reference in its entirety.

### BACKGROUND

### Field

The present invention relates to augmented reality, and, more particularly, to approaches for the provision and integration of machine vision and imagery systems.

### Background

In augmented reality environments, a user may view an integration of artificial or virtual graphics with the user's natural surroundings. In some early implementations of augmented reality, graphics were displayed, sometime seemingly arbitrarily, among or within a user's natural surroundings using, for example, augmented reality goggles. For instance, in such early days, a graphic of a butterfly may have been introduced into the augmented reality view while the user views various natural surroundings, regardless of whether the butterfly has any relevance to anything the user is seeing naturally. Today, more sophisticated implementations of augmented reality are available, whereby a user may be able to apply augmented reality features directly to objects or structures of the user's natural surroundings. For example, an object sitting on a table may be recognized and thereby re-rendered with a different color or different physical attributes in the augmented reality environment.

Modern day processors enable such recognition and re-rendering capabilities to be performed in real-time. Furthermore, there has been a proliferation of algorithms, both public and proprietary that have been published or otherwise made available. Despite the proliferation of these algorithms, there is no meaningful approach for the efficient and effective utilization of these algorithms. There is also no meaningful approach for a system to publish orchestrated algorithms that can be easily consumed in near real time by current machine vision, virtual reality or augmented reality devices.

### BRIEF SUMMARY

This section is for the purpose of summarizing some aspects of the present disclosure and to briefly introduce some preferred embodiments. Simplifications or omissions may be made to avoid obscuring the purpose of the section. Such simplifications or omissions are not intended to limit the scope of the present disclosure. Consistent with the principles of the present disclosure as embodied and broadly described herein, embodiments of an artificial intelligence (AI) combination platform provide for the efficient and effective utilization of these algorithms. In particular, the AI combination platform (which includes one or more of an algorithm mixer engine, retrospective search engine, algorithm recommendation engine, quality assurance engine, algorithm certification engine, and perception engine) orchestrates and automates the processes of selecting, building, testing, and delivering new or integrated algorithms (e.g., vision and other algorithms) that can be published or leveraged in near real time by sensors, hardware or applications.

In some embodiments, the algorithm mixer engine allows user input to select one or more algorithms, e.g., vision algorithms. Based on the selection, the algorithm mixer engine creates a custom algorithm package (e.g., a machine vision algorithm package), and thereby generates an algorithm list that reflects the custom machine vision package. The algorithm mixer engine processes the custom machine vision package as an overlay to run on connected machine vision devices. The algorithm mixer engine further processes the package for use in the selection process. Finally, the AI combination platform publishes the algorithm package for public or proprietary use.

In some embodiments, the algorithm mixer engine allows automated provisioning based on the algorithm list. Based on the algorithm list, the processor verifies that the algorithm package selected is not a duplicate. If it is a duplicate, the existing package is recycled. If the algorithm package is new, the associated package is created. If the algorithm package is not new, the package is reused from the repository. In either approach, the package modules are combined to provide the custom machine vision package.

Further features and advantages of the disclosure, as well as the structure and operation of various embodiments of the present disclosure, are described in detail below with reference to the accompanying drawings. It is noted that the disclosure is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 illustrates an exemplary platform for the augmented reality provided by the AI combination platform, in accordance with embodiments of the present invention.

FIG. 2 illustrates an exemplary architecture by which augmented reality models may be created, in accordance with embodiments of the present invention.

FIG. 3 illustrates an architecture for an augmented reality that uses augmented middleware, in accordance with embodiments of the present invention.

FIG. 4 illustrates two different approaches by which augmented reality models may be created, in accordance with embodiments of the present invention.

FIG. 5 illustrates an organization of augment reality models for use with the middleware, in accordance with embodiments of the present invention.

FIG. 6 illustrates the various roles of users with AI combination platform 180, where the users include Pipeline Architect, Domain Expert and End User, in accordance with embodiments of the present invention.

FIG. 7 illustrates an exemplary algorithm mixer engine data flow, in accordance with embodiments of the present invention.

FIG. 8 provides a further illustration of an exemplary AI combination platform, in accordance with embodiments of the present invention.

FIG. 9 illustrates an exemplary work flow, in accordance with embodiment of the present invention.

FIG. 10 illustrates a further exemplary work flow, in accordance with embodiment of the present invention.

FIG. 11 is an example system useable to implement embodiments.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

The disclosure will be better understood from the following descriptions of various “embodiments” of the disclosure. Thus, specific “embodiments” are views of the disclosure, but each does not itself represent the whole disclosure. In many cases individual elements from one particular embodiment may be substituted for different elements in another embodiment carrying out a similar or corresponding function. It is to be appreciated that the Detailed Description section, and not the Summary and Abstract sections, is intended to be used to interpret the claims. The Summary and Abstract sections can set forth one or more but not all exemplary embodiments of the present disclosure as contemplated by the inventor(s), and thus, are not intended to limit the present disclosure and the appended claims in any way.

Augmented reality is generally the enhanced view of a real and physical environment in which virtual elements are blended with the real elements. Augmented reality is typically defined as a view of the real world that has the following three characteristics: (a) real and virtual elements are blended in the real environment, (b) the view is real-time interactive, and (c) the computer generated virtual objects are fused with the three-dimensional real world. The concept of augmented reality falls between reality and virtuality, but is closer to the reality end of the spectrum since virtual elements are added to the real environment. In contrast, the concept of augmented virtuality is closer to the virtual reality since the user is completely immersed in the simulated environments. Augmented reality combines a view of reality with virtual content in real time in order to provide an interface to enhance human perception of and interaction with the real world.

At the heart of an augmented reality system is a vision recognition system and a 3D rendering engine. This is because the ultimate goal of augmented reality is to blend the virtual elements with the real elements. Typically, many algorithms in computer vision mimic a human being's brain and how it processes visual information and recognizes patterns. For example, one algorithmic approach uses a feature-based vision recognition system that consists of a type of neural network known as “self-organizing map” together with a collection of global features for expected settings to provide the augmented reality.

The present disclosure uses the term “computer vision” with the intent that the usage of this term includes both the overlapping notions of “computer vision” and “machine vision.” These overlapping notions in fact use similar components, such as a processing device, an imaging device, and image processing software, such that distinctions between “computer vision” and “machine vision” mostly revolve around the usage of the system. Typically, the term “machine vision” refers to the use of computer vision in a manufacturing or industrial setting. Often, in such a setting, a machine vision system will take various actions based on its recognition of certain pre-programmed features of the usage of this term is not meant to exclude the concept of “machine version.” Thus, in this application, the term “computer vision” is a broader term than “machine vision” in that it encompasses contexts outside of industrial settings.

This disclosure describes an artificial intelligence (AI) combination platform. The objective of AI combination platform is to address machine perception so that the selection and aggregation of algorithms provides a published vision that mirrors the same understanding as that provided by human interactions with the surroundings i.e., the human perception. Put another way, AI combination platform enables virtual and augmented reality to create a real time, fluid, immersive experience that is unique for each user/consumer.

More broadly, AI combination platform provides one or more of a number of functionalities that support sophisticated algorithm development, updating of those algorithms, re-use of those algorithms, and visualization of the results of those algorithms for interpretations by end-users of the resulting model outputs. From a wide variety of data sources, algorithms from existing algorithm repositories, as well as new algorithms, are applied to those data sources to provide outputs relevant to the goals of the end-users. In an embodiment, visualization of those outputs enables a common depiction of those outputs to be deployed so that end-users may readily appreciate and compare those outputs. This common depiction is particularly helpful where human decision making is required in terms of resolution of conflicts of information, detection of ambiguities, selection of a preferred algorithm or more generally feedback to the process in terms of the outputs of particular algorithms compared to a user's desired goals. In some embodiments, the common depiction may also serve to provide a common computer-readable format for input into other computers for subsequent processing and analysis.

In certain embodiments, the common depiction may also serve to support the presentation of multiple outputs complete with a computed accuracy for each output. In an automated AI combination platform embodiment, the presentation of multiple outputs complete with a computed error for each output is not needed as the automated platform embodiment makes decision based on the computed accuracy of the respective outputs. In a human-assisted AI combination platform embodiment, the computed accuracy may be used to support the human decision making. In the iterative refinement of the algorithms, the human choices as well as the computed accuracies may be used to index the performance of the respective algorithms for subsequent re-use.

In the pipeline definition portion of the AI combination platform workflow, a pipeline architect will select possible algorithms that are expected to be used to analyze the incoming data from the available data sources. The selected algorithms analyze the incoming data streams to identify information elements in those data streams. For example, for one or more incoming data streams that provide vision of a crowd, one or more algorithms may be selected that provide information elements such as identification of clothing (e.g., Nike, Izod, etc.) Other algorithms may be selected that are appropriate for the provision of information elements associated with potential crowd threats, e.g., possession of a weapon. Such algorithms are selected from one or more algorithm repositories and the respective outputs are provided, with an accuracy estimate being provided in some embodiments. The domain expert may review the output (e.g., information elements) of the algorithms used and provide supervised training of the processing of the data. The domain expert may also note the correlation of algorithm output with other outputs in forming an opinion on the validity of the algorithm output. For example, location of an armed robber dressed in a certain type of clothing in a large crowd may require the correlation of the output of a number of algorithms for the domain expert to make a choice of the better performing algorithms. Based on the output provided, and correlations of the output with other outputs, the domain expert may identify a superior algorithm, and that superior algorithm may be indexed and stored in the algorithm repository. AI combination platform is further cognizant of which algorithms in the algorithm repository appear to be selected and/or used for particular uses. The recommendation engine in AI combination platform is then able to provide a recommended algorithm based on the historical choices made by domain experts for particular uses.

The AI combination platform includes one or more of the following engines: (1) algorithm mixer engine, (2) retrospective search engine, (3) algorithm recommendation engine, (4) quality assurance engine, (5) certification engine, and (6) perception engine. With respect to the first engine, the algorithm mixer engine identifies functionality and capabilities of a portion or the entire algorithm. This engine allows developers (both coders and non-coders) to edit and create algorithms with desired precision, efficiency, and flexibility. The algorithm mixer engine may be used on existing and new algorithms. Furthermore, the algorithm mixer engine may include the capability to probe a given algorithm for the “DNA” or pedigree of that algorithm. By analyzing the DNA of an algorithm, the algorithm mixer engine may edit the algorithm to remove undesired or dangerous aspects of the algorithm. The editing capability of the algorithm mixer engine is akin to gene splicing whereby harmful genes may be removed.

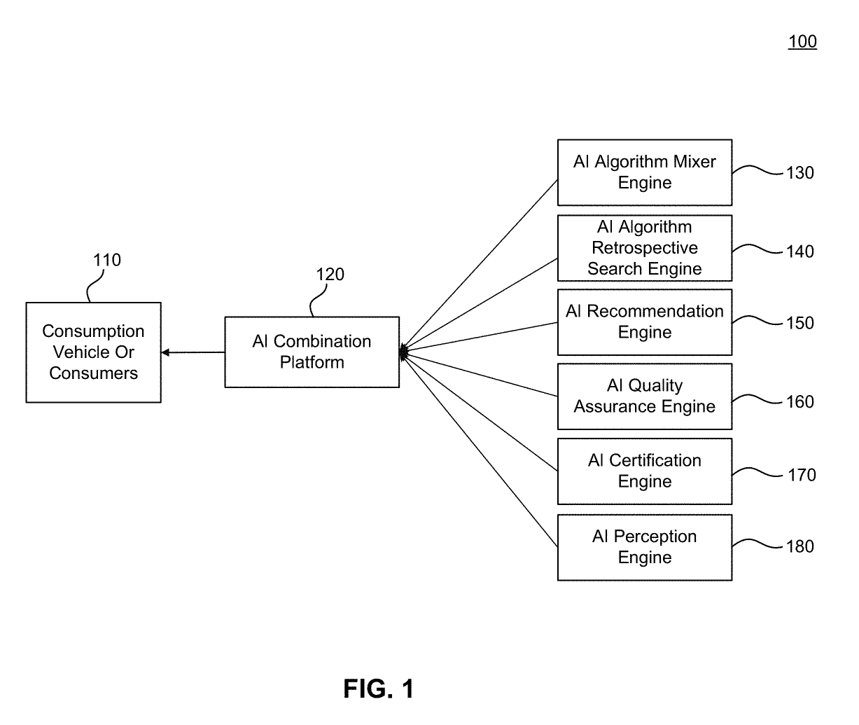

FIG. 1 illustrates an exemplary platform for the augmented reality provided by the AI combination platform, in accordance with embodiments of the present disclosure. For example, a user may receive the augmented reality via a display system that may be a head-mounted augmented reality system located in front of the eyes of the user. In addition, a speaker or headphones may be employed to provide audio information. Non-limiting examples of displays include helmet-based displays, goggles, windshields, instrument displays, transparent displays and heads-up displays. Appropriate connectivity is provided to the AI combination engine. AI combination engine runs on one or more processors, which may include memory, sensors, image capture devices (e.g., cameras), microphones, radio devices, GPS devices, gyroscopes, inertial measurement units, accelerometers, and compasses. The one or more processes may communicate via communication links to other modules that are illustrated in the subsequent Figures in this specification. For example, repositories (including point cloud repositories) may be coupled to the one or more processors.

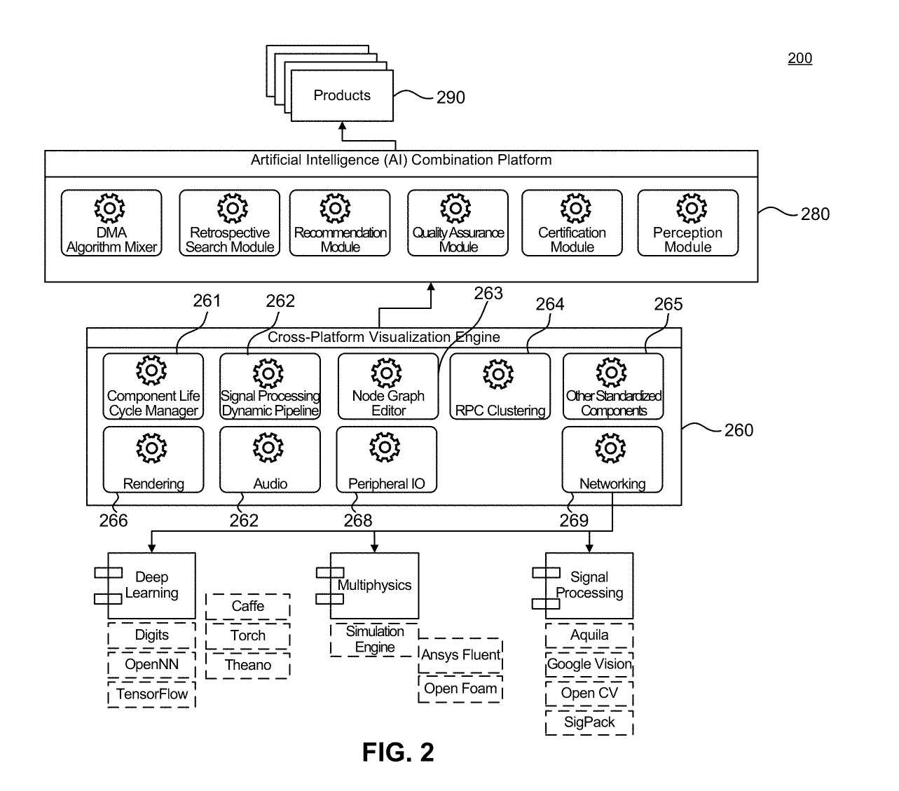

FIG. 2 illustrates an exemplary architecture by which augmented reality models may be created, in accordance with embodiments of the present invention. Shown in this exemplary architecture is a multi-level software architecture that features an AI combination platform middleware that supports various automated algorithm generation processes. The AI combination platform uses couplings to standard functionality and user-interface modules for the provision of, for example, standard scientific tools and libraries. The AI combination platform middleware also supports interfaces to end-user products that are consumers of the models (e.g., augmented reality models) resulting from the AI combination platform. Further specifics of this architecture are provided below.

In an embodiment of this multi-level software architecture, AI combination platform 280 interfaces with standard functionality and user-interface modules 260, with end-user products 290 developed using AI combination platform 280. Standard functionality and user-interface modules 260 provide the underlying framework to support multiple parallel high-performance signal-processing modular pipelines, user interfaces, advanced audio and video processing capabilities, and connectivity to standard scientific libraries and modules. In one exemplary embodiment, the standard functionality and user-interface modules 260 include on or more of component lifecycle manager 261, signal processing dynamic pipeline 262, node graph editor 263, RPC (remote procedure call) clustering 264, other standardized components 265, rendering 266, audio 267, peripheral input/output 268, networking 269, signal processing modules 270, multi-physics modules 271, and deep learning modules 272.

Each of these modules provides exemplary functionality as follows. Component lifecycle manager 261 is a core module that is responsible for instantiation and cleanup of all other dynamically loaded components. As one of the backbone modules in the AI combination platform, it centralizes and abstracts the “life” of component memory in a standardized way and assists with system stability by minimizing memory leaks and other common errors. It also provides an interface which allows easy engine integration of third-party components. These modules may be configured to be standardized plug-in modules to facilitate the ready incorporation of these components into the framework. Tighter integration between the modules and the platform may also be employed to facilitate increased processing performance. Looser integration between the modules and the platform may also be employed to facilitate increased flexibility and extensibility.

AI combination platform 280 includes algorithm mixer 281, as well as other companion functionality such as retrospective search module 282, recommendation module 283, quality assurance module 284, and certification module 285. The design of the AI combination platform facilitates an adaptable signal processing pipeline in support of the development of AI models and algorithms. As part of this support, the AI combination platform is able to branch and merge multiple computing paths at run-time, and thereby enable a dynamically-generated dataflow in support of the automated algorithm generation process of the AI combination platform. For example, node graph editor 263 together with signal processing dynamic pipeline 262 facilitates the generation of new iterations of the pipeline.

In addition, the algorithm mixer engine facilitates the remixing of the algorithmic pipeline to better fine tune the algorithmic output being provided to the domain expert and the end user. Specifically, the algorithm mixer engine may combine two or more algorithms that together provide a superior result. Specifically, the algorithm mixer engine may identify portions of the algorithmic code that constitute a deficiency and thereby lower the quality of the output of the algorithm. Identification of the deficient code portion is made by engines within the AI combination platform and includes the following: (1) identification of a duplicate code element by the algorithm mixer engine; (2) identification of a defective code element by the certification engine; and (3) identification of an ineffective code element by the certification engine. The latter two identifications may be achieved by artificial learning by AI combination platform that correlates poor performance of multiple algorithms, each of which shares the defective or ineffective code element.

In certain embodiments, the algorithm mixer engine within the AI combination platform provides a switching function between two or more algorithms. As part of this capability, the algorithm mixer engine contains an innovative middleware that is configured to be able to allow different algorithms the ability to use the same source of data. For example, a Caffe-based algorithm and a TensorFlow-based algorithm use different input data formatting. In embodiments, the AI combination platform uses middleware that can adjust or translate a common data stream for use in a multitude of different algorithms to enable the resulting different outputs to be readily compared. Furthermore, the AI combination platform also outputs the results of multiple algorithms in a common output format for ready visualization, comparison and understanding. This approach overcomes a significant disadvantage of other approaches in that while there are numerous approaches to analyze various input data steams such as speech, images, videos, texts, metadata, and other data from sensor devices. However, these approaches provide incompatible outputs with derived information that is not easily combined or compared with each other. Using only one approach may result in deficient performance resulting from an inferior algorithm for the particular input data stream. Also, it is often unclear which derived information elements should be considered for hypotheses where a number of different outputs may need to be compared and correlated in order to form an overall judgment of a particular situation.

Such flexibility enables a variety of potential algorithms to be readily used, compared and chosen on the basis of performance for a desired output. Furthermore, not only may a domain expert make an informed choice, but the AI combination platform may readily monitor the choices made over time by a multitude of domain experts for a variety of scenarios and index the algorithms accordingly. That monitoring and learning by the AI combination platform provides a robust AI engine to provide suitable algorithm choices based on a solid provenance record provided by the machine learning that is informed by the choices made by the domain expert.

A component of the AI combination platform architecture is the artificial intelligence recommendation engine (“AI recommendation engine”). The AI recommendation engine begins with default settings, but learns to adapt its understanding of a user over time. For example, the AI recommendation engine learns the personality of the user, the actions of the user, and makes recommendations of models based on what it has learned. This provides the machine perception model that is custom built and completely unique to each user. These machine perception models give the user a fully immersive, fluid, and completely unique experience. If a recommended model is not appropriate, the AI recommendation engine updates its learning and pushes updated recommendations. In addition, the AI recommendation engine makes recommendations based on not only the user, but also the environment in which the user is located. Changes to either the user or the environment result in different and unique recommendations. Not only does the AI combination platform through its AI recommendation engine learn over time from feedback from the user, but the AI recommendation engine also increases its understanding of the algorithms in the libraries. For example, should an AI recommendation engine learn through its AI quality assurance engine (“AI QA engine”) that an algorithm contains harmful information or acts inappropriately, the AI quality assurance engine learns to block that algorithm with the harmful “DNA.”

With respect to the next engine, the quality assurance engine may employ an algorithm immune system to prevent and block harmful algorithms. The certification engine, a component of the AI immune system, creates a rating system for algorithms used by all consumption vehicles and/or consumers. For example, the certification engine may create a rating similar to a motion picture rating of G, PG, PG-13 and R. In another example, the certification engine will also classify the type of algorithm based on usage. The algorithm recommendation engine recommends algorithms based on desired functionality and outcome. The perception engine creates perception from both a machine perspective and a human perspective. The retrospective search engine enables coders and non-coders to search functionality of algorithms based on desired outcome. The retrospective search engine also allows algorithm models to be used on historically recorded images/videos and/or data for retrospective search and analysis. Further, the retrospective search engine also allows the end user of virtual reality and/or augmented reality to use commands to search and then upload new models based on their environment.

As part of the AI combination platform, an approach for tracking distinctive characteristics of each algorithm is important for purposes of identification, rating and prevention of harmful errors. To meet this requirement, and as noted above, a quality assurance engine may employ an algorithm immune system to prevent and block harmful algorithms, and a certification engine creates a rating system for algorithms used by all consumption vehicles and/or consumers. In an embodiment, distinguishing metadata for each algorithm is maintained so that the certification engine and the algorithm immune system can be assured of the pedigree of the particular algorithm. Such metadata explains and tracks how, when and where (point of origin) an algorithm was created, evolved or licensed. In other words, the metadata provides the genealogy or pedigree of the algorithm. Indicia of the metadata include; (a) it may mark the algorithm beginning with the metadata of the original algorithm; (b) the metadata is similar to the metadata applied to every image taken by a CMOS sensor, but in this case, the metadata is applied to algorithms; (c) the metadata may include quantitative measures such as its score, its efficient, and its opportunity for improvement compared to a goal (ideal or otherwise); (d) the metadata may be read by machine or human, and may be combined with “like or similar” algorithms.

The metadata plays a pivotal role in providing appropriate equivalent of a “breadcrumb trail” in order to provide: (a) historical context of algorithm defects, (b) identify failure points within a genealogical context, (c) track and measure evolutionary progress in efficiency, and (d) to track algorithmic risks in a genealogical context. Furthermore, the metadata may be employed in the machine-to-machine interactions within the AI combination platform. The use of such metadata ensures that algorithmic evolutionary enhancements are regulated by the metadata constraints of efficiency and risk metrics. In additional embodiments, the algorithmic mixer engine will not mix algorithms absent metadata for the algorithms involved.

In some embodiments, the metadata may include the point of origin, as well as to understand the evolutionary stages that a particular algorithm may have undergone. Below is an exemplary table for the metadata of a particular algorithm:

AI Combination Platform Metadata

| | |
|---|---|
| Date and time (original) | 2016:04:11 16:45:32 |
| Date and time (digitized) | 2016:04:11 16:45:32 |
| Components configuration | Pixel |
| Origin | Python |
| Mutations | 40021 |
| Learned parameters | 34929281 |
| Type | Evolutionary |
| Solver | RMSprop |
| DB origin | 20.1 gb |
| Maker | 432 bytes unknown data |
| Version | Rubix version 1.0 |
| Efficiency | 90% |
| Cross trained | Alexnet |
| License | CC-BY Non Commercial |
| Evolution Score | 98% |
| Rating | PG-13 |
| Nefarious Rating | .01% |

In this embodiment, the metadata for a particular algorithm is a table having multiple properties for which values are provided. Such metadata provide a basis by which the pedigree of the particular algorithm may be established. These exemplary properties include relevant dates and times of origination, components configuration (e.g., pixel-based versus image-based algorithm), originating program, number of mutations to which this algorithm has undergone to get to this state, learned parameters (an indication of the number of the connections made in the neural network), type of algorithm, solver (type of tool used in the generation of this algorithm), DB origin, maker (indication of domain expert involved), version (version of the AI combination platform in which the algorithm was generated), efficiency (quantitative indication of proximity of algorithm to a desired goal), cross trained (indication of cross training involved), license (indication of licenses involved), evolution score (quantitative assessment of the evolutionary advancement to a particular goal), rating (suitability for particular audiences), and nefarious rating (an assessment as to the likelihood of an unacceptable risk).

In an embodiment, an AI programming code interpreter supports the interoperability of various tools that communicate with the AI combination platform. In an embodiment, interoperability in an AI context includes a hierarchical set of capabilities, include interchangeability at the data level, control of the sequence, looping and execution of the AI workflows, as well as to support a multilingual language model for rapid algorithmic development. At the data level, interchangeability includes the ability to translate data structures from one tool to another tool. For example, the AI programming code interpreter may translate logical data structures between a C++-based programming language and a Python-based programming language. In an exemplary embodiment of the language, the language is an aggregate language formed by the AI combination platform by extracting aspects of the input programming language to form the most efficient resulting language. This new machine-readable language does not follow the conventional relational operator-structure syntax of a language, but prioritizes confidentiality and transmission efficiency when incorporated in media such as imagery. This language is not intended to be readable by humans, nor by machines that have not been trained on the evolved language. In a more complex embodiment, an AI programming code interpreter may encode semantics of the two or more programming languages involved rather than comparing code to code translations. In such an embodiment, the AI programming code interpreter may be used to translate between binaries such as Caffe and TensorFlow that are based on traditional programming languages. In further embodiment, the AI programming code interpreter may perform automated translations of languages that it had not been taught to translate, using one or more underlying AI learning algorithms. In some embodiments, the AI driven programming models learn a form of “interlingua” (i.e., a type of artificial language) representation for the multilingual model between all of the involved programming languages. The interlingua may be used within the AI combination platform to explain how known and unknown code may be translated. Thus, this interlingua becomes a new “language” that will contain abstractions for defining and manipulating data structures while controlling the execution and workflows for throughout the AI combination platform.

Machine perception is a crucial issue in the shaping of the resulting output of the AI combination platform architecture. Interwoven within the term “machine perception” is the difficult problem that is solved by the perception engine within the AI combination platform architecture, namely “machine perception” tackles the challenges of understanding images, sounds, video and location that are unique to each user. When the challenge of “machine perception” is not addressed, problems materialize that undermine the value of augmented reality. For example, a vision module operating without a machine perception solution will often produce meaningless results, such as a random butterfly, a detached face drifting aimlessly in mid-air and any other unintended or unwanted artifact. These are problems unlikely to result from human action. A human observer of the scene is unlikely to make such a mistake. As noted above, the objective of the perception engine within the AI combination platform is to address machine perception so that the selection and aggregation of algorithms provides a published vision that mirrors the same understanding as that provided by human interactions with the surroundings i.e., the human perception. Put another way, the perception engine within the AI combination platform enables virtual and augmented reality to create a real time, fluid, immersive experience that is unique for each user/consumer.

The user's environment will help drive the machine perception of the perception engine within the AI combination platform that enables unique location identification. This can be done with and/or without the need for existing location identifying technologies. For example, the unique identifiers associated with a given location provide a fingerprint that may be used to identify that location. Point clouds provide large data sets that allow the unique identifiers to be matched to the particular location. For example, a room at a particular street address contains unique identifiers that permit its location to be learned from point cloud data sets that associate the same set of identifiers with the particular location. Similarly, the sound and scent profiles created by specific identifiers are used along with other environmental, weather, seasonal and time conditions to identify a user's location.

The machine perception provided by the perception engine within the AI combination platform is updated in real-time. The perception engine within the AI combination platform is connected to relevant real-time data feeds from which relevant information for a given consumer is filtered. As the filtered relevant information necessitates an updated recommendation, such a recommendation is pushed to the user.

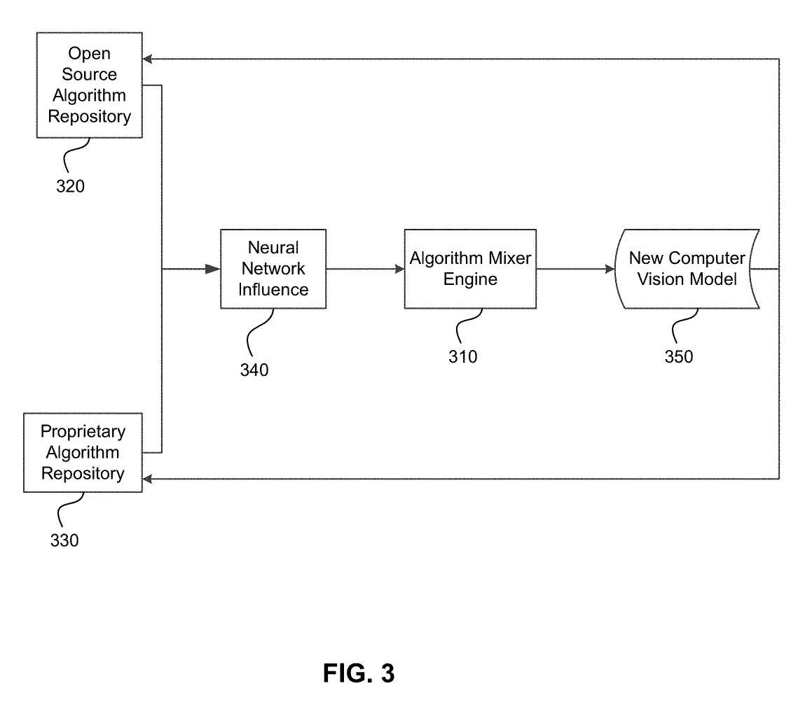

FIG. 3 illustrates an exemplary implementation of the algorithm orchestration module 310 and related architecture, i.e., the AI combination platform. Existing algorithms are stored in two repositories, open source algorithm repository 320 and proprietary algorithm repository 330. Both algorithm repositories 320, 330 provide means by which information relevant to a given scenario may be provided. For example, an algorithm in algorithm repositories 320, 330 may use features based on an appearance of an object at certain interest points to select relevant information (e.g., an image) in support of augmented reality. Different algorithms provide different capabilities to algorithm orchestration module 310. For example, different algorithms may have access to different libraries of images. Different algorithm may also provide different capabilities with respect to the libraries of images, such as determination of relevant images based on a request. Open source algorithm repository 320 and proprietary algorithm repository 330 differ from each other in that an open source algorithm repository is freely available, for example, on the Internet. By contrast, a proprietary algorithm repository is usually owned by the organization that developed it, almost always has major restrictions on its use, and its source code is almost always maintained as a trade secret. An open source algorithm repository may be distributed under a variety of licensing terms, but typically the repository may be used without paying a license fee, and anyone can modify the repository to add capabilities not envisaged by its originators.

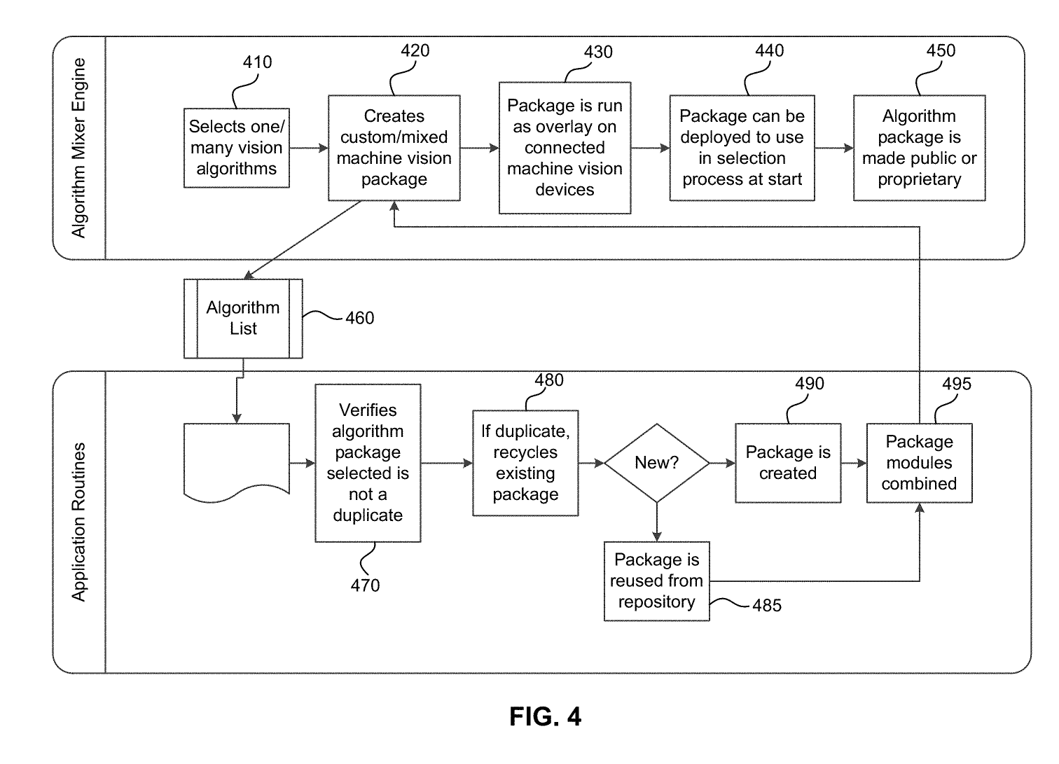

FIG. 4 illustrates two different approaches by which augmented reality models may be created, in accordance with embodiments of the present invention. For example, in step 410, the algorithm mixer engine allows user input to select one or more vision algorithms. Based on the selection, in step 420, the algorithm mixer engine creates a custom machine vision package, and thereby generates an algorithm list 460 that reflects the custom machine vision package. In step 430, the algorithm mixer engine processes the custom machine vision package as an overlay to run on connected machine vision devices. In step 440, the algorithm mixer engine further processes the package for use in the selection process. Finally, in step 450, the algorithm mixer engine publishes the algorithm package for public or proprietary use.

Still referring to FIG. 4, the algorithm mixer engine allows automated provisioning based on the algorithm list. Based on the algorithm list 460, the processor verifies that the algorithm package selected is not a duplicate in step 470. In step 480, if it is a duplicate, the existing package is recycled. If the algorithm package is new, in step 485, the associated package is created. If the algorithm package is not new, in step 490, the package is reused from the repository. In either approach, in step 495, the package modules are combined to provide the custom machine vision package.

As noted above, in step 420, the algorithm mixer engine creates a custom machine vision package, or more generally, a custom algorithm package. In a typical scenario, step 420 makes an adjustment (e.g., an improvement) to one or more algorithms based on identified anomalies and/or new user requirements. For example, an existing algorithm may identify a particular piece of code in an algorithm mix as having an artifact that results in an undesired resulting output. Methods of identifying the particular piece of code are described above in the description of the metadata used to properly describe the pedigree of an algorithm. Having identified a potential piece of code as potentially including an artifact, either deletion or replacement, the next stage in step 420 is to either delete or replace the problematic code. Where no appropriate replacement code is identified, the troublesome code is simply deleted from the mainstream algorithm, and stored in an artifact algorithm database. In the alternative, where replacement code is identified, this replacement code replaces the troublesome code in the mainstream algorithm. In the updated mainstream algorithm, its performance is monitored under various operating scenarios and where possible quantitative metrics are maintained to measure its performance.

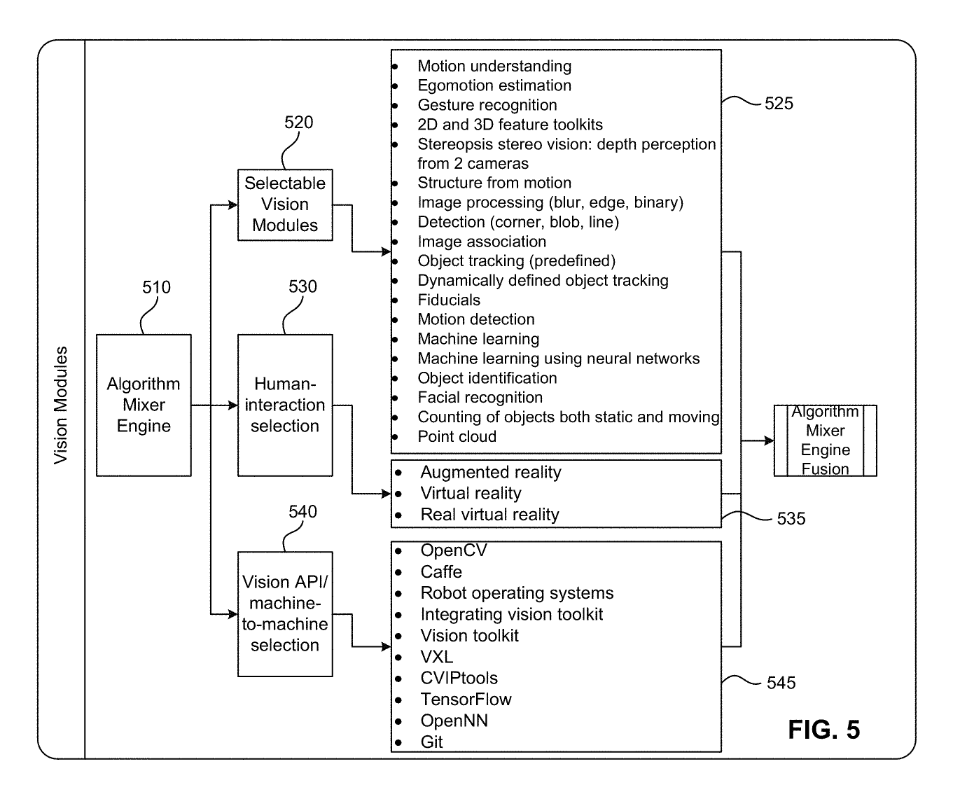

FIG. 5 illustrates the individual functionalities that are selected during the creation of augmented reality models, in accordance with embodiments of the present invention. The algorithm mixer engine vision modules 510 may be broken into three selection approaches, selectable vision modules 520, algorithm mixer engine human-interaction selection 530, and vision API/machine-to-machine selection 540. This orchestration middleware also allows the integration of independent algorithm models that can be integrated and utilized by video or imagery systems. The video or imagery systems can be working independently or in conjunction. Selectable vision modules 520 includes the following algorithm examples 525: motion understanding, egomotion estimation, gesture recognition, 2D and 3D feature toolkits, stereopsis stereo vision, structure from motion, image processing, image detection, image association, object tracking, dynamically defined object tracking, fiducials, motion detection, machine learning, machine learning using neural networks, object identification, facial recognition, point cloud and counting of static and moving objects. In this embodiment, AI combination platform human-interaction selection 530 includes selecting from one of 535 augmented reality, virtual reality and real virtual reality. Vision API/machine-to-machine selection 540 includes selecting via an application programmer interface (API) at least one of the following computer vision libraries 545: OpenCV, Caffe, robot operating systems, integrating vision toolkit, vision toolkit, VXL, CVIPtools, TensorFlow, OpenNN and Git.

For instance, a satellite leveraging an object-tracking algorithm model may detect a potential security threat. Based on location threshold, that specific object-tracking algorithm model can be published and utilized by any location-significant drone video system, surveillance camera, phone camera or video sensor to help track the threat. New or integrated algorithms can be pushed or pulled from the repository and published in near real time to the entire group of location-significant consumption devices as threat dynamics change.

Video and imagery systems exemplary embodiments include but are not limited to: virtual reality, deprecated reality, immersion reality, augmented reality, satellite video and imagery, drone/unmanned aircraft systems (UAS)/unmanned aerial vehicle (UAV) video and imagery, phone video and imagery, camera video and imagery, surveillance video and imagery, with interfaces such as brain computer interface, direct neural interface and the like.

In further embodiments, this orchestration middleware can also be leveraged by traditional types of algorithms. Examples include but are not limited to: simple recursive algorithms, backtracking algorithms, divide-and-conquer algorithms, dynamic programming algorithms, greedy algorithms, branch-and-bound algorithms concept, and brute force algorithms.

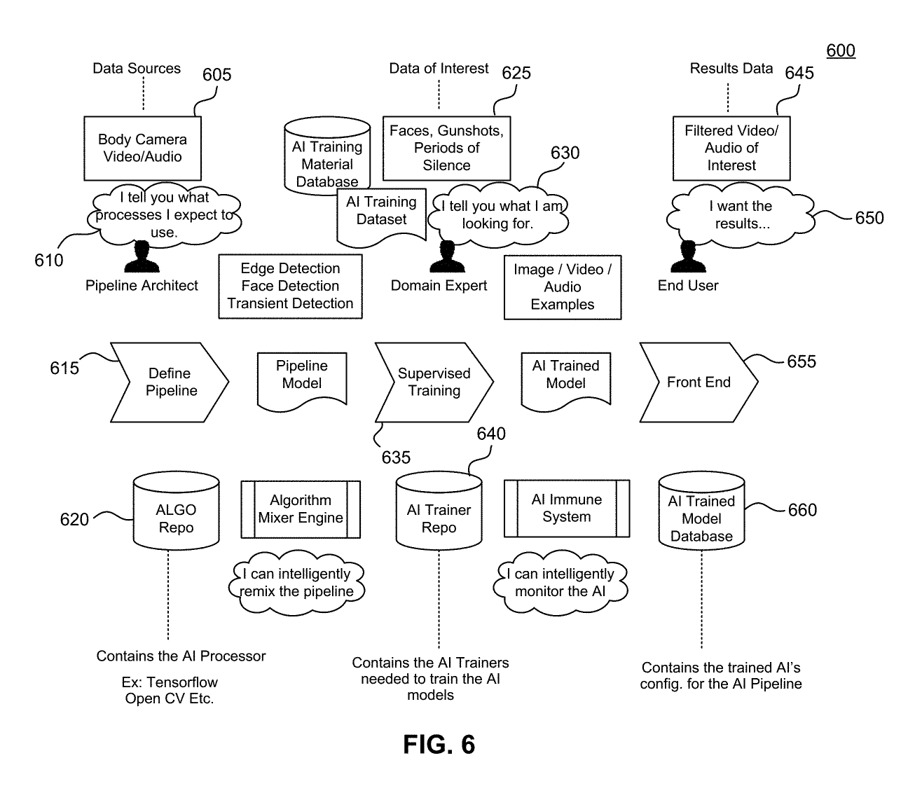

AI combination platform 280 supports a variety of use models, which are described further below. To facilitate this discussion, FIG. 6 illustrates the various roles of users with AI combination platform 280, where the users include Pipeline Architect, Domain Expert and End User. The Pipeline Architect is an individual that has an expertise in signal processing and pipeline construction but is not necessarily a software developer. The Pipeline Architect will communicate with the domain expert who informs the Pipeline Architect of the data requirements needed to solve a problem. Accordingly, the Pipeline Architect is most interested in defining the desired pipeline which serves as the “workbench” for the domain expert to work in. In an exemplary case, the Pipeline Architect may set up a pipeline to handle preprocessing of video and audio to ensure homogenous input into TensorFlow along with additional useful meta data.

FIG. 6 also illustrates the role of another user, the Domain Expert. The Domain Expert is an individual that has a domain expertise in the subject domain and understands AI systems, but does not necessarily understand advanced signal processing or software development. The Domain Expert has received a request to solve a problem and wishes to automate it using AI technologies, such as AI combination platform 280. The Domain Expert communicates this information to the Pipeline Architect who helps set up the “workbench” in order for the Domain Expert to train the AI to find one or more solutions. For example, the Domain Expert may train an AI model to search for a particular person within a huge collection of body cam footage. To do this, the Domain Expert instructs the Pipeline Architect to filter the input footage down to just images of faces for comparison.

FIG. 6 also illustrates the role of another user, the End User. The End User has a problem but minimal, if any, expertise in the technology required to obtain a solution. The End User communicates with the Domain Expert to request an automated task or tool (here an AI task or tool) to provide the desired solution. For example, a police department wants to speed up the time it takes to locate a suspect or some evidence amongst hours of footage, where such efforts are currently reviewed manually.

Embodiments of the present approach assist the Domain Expert and/or eliminate the role of the Pipeline Architect in some cases. In some use cases, one of the main functions of embodiments of the present AI algorithm approach is to regenerate the pipeline in new variations that could potentially produce better results, thereby assisting the Domain Expert. In other uses cases, the present AI algorithm approach may be to assist the Domain Expert by synthesizing the parts of the pipeline that the Domain Expert may be unfamiliar with. For example, in some use cases, a pipeline can be generated merely by providing the system with the expected data and key pieces of information to validate the synthesized results. Embodiments of the present approach would then synthesize the most optimal combination of pipelines nodes to provide the desired output.

An exemplary use model for the AI combination platform is shown in FIG. 6. Data sources 605 provide data for analysis in a given scenario. Data sources 605 include data streams such as speech, images, videos, texts, metadata, and other data from sensor devices. In an embodiment, data source 605 may be the audio and video from a body camera. For data sources 605, pipeline architect 610 may determine the algorithms expected to be used to support the operational scenarios for which data sources, i.e., pipeline architect 610 defines the pipeline. The algorithms selected may come from algorithm repository 620. The pipeline defined by pipeline architect 610 acts on data from data sources 605 to identify events of interest 625. The focus of the particular events of interest 625 serves to support supervised training of the models. AI trainer repository 640 contains a collection of known trained algorithms that can be used to cross-train existing models or new models. In such training of the models, the algorithm mixer engine facilities the ability to mix various algorithms to improve those algorithms and to form composite algorithms to provide an improved resulting output. The result of the supervised training is an AI trained model that produces results (e.g., filtered video/audio of interest 645) for viewing by end user 650. Such results may be displayed by front end 655 for ease of viewing by end user 650. Also, AI trained model database 660 stores the configuration of algorithms used in the AI pipeline.

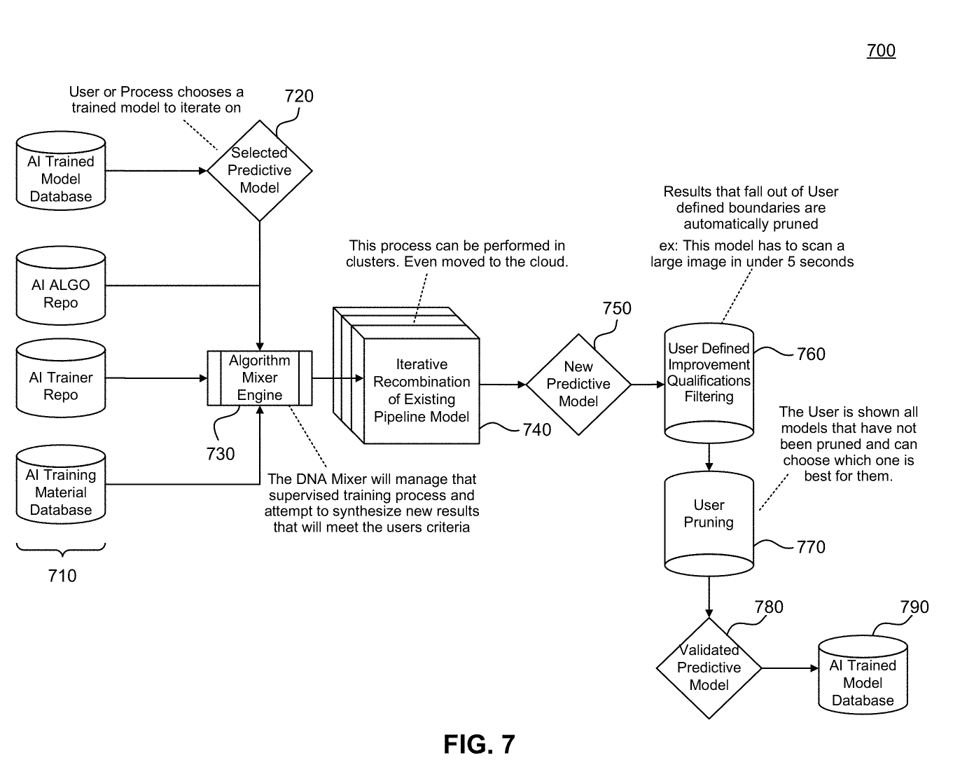

An exemplary an exemplary algorithm mixer engine data flow is shown in FIG. 7. A variety of sources of algorithms 710 provide the input algorithms to the algorithm mixer engine data flow. Sources of algorithms 710 include AI trained model database, AI algorithm repository, AI trainer repository and AI training material database. At 720, selection of a predictive model is made by a user or process, and forms the basis of the trained model to iterate on. Inputs to algorithm mixer engine 730 include the selected predictive model 720 as well as AI algorithm repository, AI trainer repository and AI training material database. Algorithm mixer engine 730 manages the supervised training process and attempts to synthesize new results that meet the user's criteria. In 740, an iterative recombination of existing pipeline model occurs as a result of algorithm mixer engine 730. In embodiments, this iterative recombination may be performed in clusters, or even moved to the cloud. As a result of the iterative recombination, a user predictive model 750 may be formed. Next, in 760, results are filtered in accordance with user requirements. For example, results that fall outside of user-defined requirements are automatically pruned. Following the filtering, in 770, the user is shown all models that have not been pruned. Based on these models being presented to the user in a comprehensive view, the user may choose which models work best for them. Based on this choice, in 780, validated predictive models are identified and are stored in AI trainer model database 790.

In the law enforcement use case, it is instructive to discuss the support provided to a variety of users in the law enforcement context. For example, a shift manager in such a context is supported in the daily review of the Body Worn Camera evidence that is uploaded at the end of the shift, based on prioritization of the videos from automatically tagged labels and rule-based sorting of each video and/or audio tracks. Similarly, an investigative detective user is supported in the identification of all of the occurrences of a suspected gang member's vehicle on a geo-location-based filter of traffic/street cameras. Furthermore, a legal review officer is also supported in making a determination about the relevance of a given footage for use in court/legal proceedings or in response to a Freedom of Information Act request by a media organization (for example, if this footage is critical to the defense or the state in an upcoming case). Such support includes support to the legal review officer to take appropriate action with the footage, including possible redaction and/or authorization of release to a relevant party.

AI combination platform 280, together with its coupled user interface, provides the following exemplary experience to an End User. AI combination platform 280 will track a certain number of hours of video footage using pre-set conditions (i.e., objects) to identify and catalog it into the results database. Once the database is built, End User will be able to search the historical database by keyword using a user interface containing a “Google-like” search box. The application will then display search results of snippets, thumbnails, and audio clips to End User.

To provide such an experience to an End User, the information needs to be processed in multiple stages in order to produce usable results for the End User. From the End User's perspective, much of the processing is internal to AI combination platform 280, and not visible to the End User beyond any settings exposed to the End User. The first stage of the multiple stages is the pre-processing stage. In this stage, any input data, as defined by the Pipeline Architect in conjunction with the Domain Expert, will first need to undergo “clean up” through multiple stages to ensure only the best data is passed through into the AI Analysis process. The clean-up stage can involve 1 or more processes but generally includes the following: (a) transform process, which ensures that the data meets the expected input format of the AI Analysis stage; (b) normalization process, which ensures data bounds are within any tolerance levels and may apply filtering and enhancements to the data set in order to ensure the AI Analysis stage can process it. For example, color correction may be applied to an image to provide additional contrast. In another example, some filtering of the audio may be used to remove interfering background noise; (c) feature extraction process, where additional filters and techniques may be applied to the data to generate additional metadata for analysis. For example, an edge detection filter may be applied to enhance visibility of license places in video footage; (d) metadata creation process, where additional filters and processes are run on the data to generate metadata that is then fed into the AI Analysis stage. For example, a motion tracking plugin can be used to track the movements of an object on film and the trajectory vectors can be passed along with the video footage.

The second stage of the multiple stages is the AI analysis stage. In this stage, the prepared data from the pre-processing stage is passed into the AI Analysis stage as required. For example, the AI Analysis stage could be TensorFlow. The next stage is the post-processing stage. This stage is responsible for producing human readable data out of the results of the AI Analysis stage. This can involve 1 or more processes, but a general flow of this stage is as follows: (a) filtering and association of data process, which provides organization and sorting of the results. This process takes the raw results and formats these results for subsequent consumption. (b) content creation process, which creates additional supporting metadata to help with the readability of the information. For example, while searching for guns within video footage, the AI algorithm might return with an image coordinate. This process might render a rectangle around the gun found inside a video image. (c) format transform process, which converts the results into more easily consumed formats. For example, a stream of processed images can be combined into a video for playback or streaming over the network.

An overview of embodiments of the present approach is as follows. Embodiments provide an algorithm mixer engine capable of generating interpretations of events and circumstances using a variety of sources of information. Those sources of information include rich sources of information, and may include irrelevant, conflicting and misleading information, as well as the critical relevant information that supports the definitive interpretations of the events and circumstances. These sources of information include the full spectrum of observable information, and include various multimedia streams of information, including images, video, speech and text. Also included in the sources of information are any metadata associated with the raw streams of information.

The generated interpretations include one or more hypotheses as to the relevant knowledge gleaned from the events and circumstances. With the generated interpretations, the algorithmic mixer may provide one or more confidence metrics for these interpretations. As the streams of information are real-time, the generated interpretations update at various intervals consistent with the additional information received in the real-time stream. Included with the generated interpretations may be structured interpretations, where the structured interpretations include appropriate linkages, cross-references and other forms of associations between various constituent elements of the interpretations. Structured interpretations are also useful in providing a common presentation schema so that a user may readily understand the one or more generated interpretations being provided. Associations include, for example, timeframes, locations and actions related to the events of interest. Also included with any generated interpretation may be identification of conflicting information. Also, embodiments of the present approach may include a derivation record for each generated element of a generated interpretation that provides details of how that generated element was determined for later auditing.

Embodiments of the algorithm mixer engine include using automated selection and optimization of algorithms, as well as taking input from a user, and to make comparisons with previously existing interpretations. By having available the multitude of interpretations and the ability to mix and match a variety of algorithms, embodiments of the present approach enable the identification of relevant patterns, conflicting information and deceptive inputs to be achieved and to be presented in a format that is readily understandable by a user.

In the above overview, troublesome code may be identified as offering sub-optimal performance using a variety of approaches, e.g., knowledge over time, neural network-based approaches and other means for anomaly detection. Other approaches may include monitoring the degree of correlation between a desired valid outcome and the outcome provided by the particular troublesome code under scrutiny. In addition to the above “performance”-based approaches, other means of identification of target code(s) for potential elimination include identification of duplicative code, overlapping code and the like. Additional deep learning techniques deployed in embodiments of the present approach include, either individually or in combination: automated model selection through calibration, rectified linear units, mini-batch stochastic gradient descent, dropout regularization, graphics programming unit (GPU) acceleration to enable fast training using large data sets, and a Nesterov momentum approach. Furthermore, feed-forward neural networks and feedback recurrent neural networks will also be used. Feed-forward neural networks, whose signals travel in only one direction from input to output, are useful for modeling relationships (i.e., mapping) between the input (predictor) variables and the output (response) variables. Feedback (including interactive or recurrent) networks use signals that travel in both directions (both input to output, and the reverse) and provide strong capabilities due to the complexity that is enabled. One example of a feedback network is a Hopfield's network that provides a clear version of a noisy input pattern by recalling a corresponding stored pattern stored within an associative memory device.

Embodiments of the present approach focus on algorithmic improvement and optimization such that the resulting output constitutes critical desired knowledge by the target client. Algorithmic improvement is an iterative approach by which artificial intelligence selects those algorithms that are superior and the process repeats. Such an approach is similar to Darwinian evolution whereby small, random changes in an organism's genetic makeup provide it with either an advantage or a disadvantage. If the advantage allows the organism to survive, that genetic mutation is passed along while disadvantages die with the organism. This same approach is applicable to artificial intelligence and is known as neuroevolution (as distinct from neural networks, which replicate the process of learning individual concepts). Neuroevolution attempts to recreate the biological process by which only the best advances, here algorithmic advances, survive. Neuroevolution is a complex process in that a wide multitude of algorithmic choices are possible, while the output is often a simple metric (e.g., does the algorithm provide a more accurate image recognition performance to a competing algorithmic choice). The algorithm with the superior accuracy survives, while the competing algorithm with the inferior accuracy dies. The process, like biological evolution, repeats itself many times.

In the context of evolutionary Artificial Intelligence approaches, “worker” algorithms may be deployed to train a master algorithm to evolve, and improve, its performance over time. At each step of the training process, the “worker” algorithms tackle the task-at-hand and report a performance metric to the master algorithm. “Worker” algorithms with a superior metric continue to be used as the basis for further “random mutations,” while those with inferior metrics are discontinued. Further enhancements including backpropagation (whereby learning may be accelerated by an improved understanding of the relationship between the input changes and the resulting output changes) may be also incorporated.

In embodiments of the present invention, this algorithm mixer engine can pull in new or existing computer vision algorithms written in Java, openCV, python, and other machine languages. The middleware interface allows the user to select one or many algorithms in near real time for analysis or pattern recognition with the ability to switch machine vision algorithms in an automated fashion. The middleware could use machine-to-machine communications to retrieve algorithms as they become available, for example git, API, or other protocols. The middleware also allows users to manually input computer vision algorithms that are stored in their private database of algorithms. The logic behind this is to allow proprietary combinations of open-source algorithms or custom-written algorithms that may be confidential or considered a trade secret. Once the algorithm models are selected, they can be saved or automatically exported to the next phases of the orchestration process.

The algorithm development user handoff from build to test to deliver is a process with clearly defined requirements. If the algorithm-build passes, it is forwarded to the testing phase; if it passes the test, it will automatically be delivered to the sensors, hardware, or applications that will consume the algorithm. If it doesn't, the process automatically routes the appropriate algorithm error information to the users. Custom machine learning control software can be implemented to provide recommended fixes or repairs during any step of the algorithm development process.

These final algorithm models are stored in a central database or repository and can be open source or proprietary. Additionally, the middleware would allow the computer vision algorithm models to be used on historically recorded images/videos for retrospective video search and analysis.

Once the algorithm models are stored in a repository, they dynamically change in the case of location services for virtual reality, deprecated reality, immersion reality, and augmented reality. Various examples illustrate the use of augmented reality. In one example would be a blind man leveraging a wearable computer vision hardware device that provided him with a description, tactility, or auditory of his surroundings. If the man were on the beach, only the beach machine vision modules would be published from the repository. This would allow the most accurate information to be provided with the least amount of computing power.

Another example would be the man going from the beach to the house. As a defined location threshold was met, the specific house computer vision models would be published for consumption by the computer vision hardware device. Dynamic computer vision models from the repository would be automatically pushed to the computer vision device through policy settings without any action required by the user. Custom content or models could be published from the repository by pull or search requests by the user.

The above examples highlight the wide variety of consumption vehicles of the output of the AI combination platform architecture. In particular, computer vision, machine vision, and augmented reality consume models produced by embodiments of the algorithm mixer engine within the AI combination platform architecture described herein. The algorithm mixer engine adds considerable value to these consumption vehicles by automation of the provision of appropriate models that are relevant to the consumption vehicles. Furthermore, these appropriate models are published in near real-time for consumption by the consumption vehicles. In addition, the algorithm mixer engine also provides a platform for both coder and non-coder alike to mix and match available algorithms for inclusion in a published model. A coder is familiar with the relevant software coding languages and may readily mix and match the appropriate algorithms. However, a non-coder does not have the same ability to mix and match algorithms by coding, but instead, may mix and match algorithms using the algorithm mixer engine provided within the AI combination platform architecture. For example, a non-coder who desires that an audio algorithm and a video algorithm, may use the algorithm mixer engine within the AI combination platform to select and then mix and match respective algorithms from each of algorithm type that will result in a new published algorithm model.

More specific details are provided for two use cases, (a) digital output media use case, and (b) law enforcement use case. In the digital output media use case, the details are provided below.

The law enforcement use case addresses the following data and analysis problem. Law enforcement organizations throughout the United States are currently rolling out body-worn camera (BWC) projects that produce an overwhelming flood of video and audio data, every hour of every day, starting from the day they are deployed in the field. The clerical and administrative personnel of the corresponding law enforcement departments are substantially under-equipped to handle their legal and professional obligations regarding the management, administration and the obligatory content review of the large numbers of frames of this content. AI combination platform 280 provides a solution to this problem, the solution being the provision of a system for the automated management, contextual labelling and workflow organization of this substantial volume of data. Contextual labelling includes such as “urgent” as for example, presence of a gun/weapon in the scene, verbal agitation/shouting of the officer indicating conflict, use of racially biased terms in the audio transcriptions, violence/conflict labelled (hitting/striking) from the motion activity in the videos. Other contextual labelling includes nudity/indecent exposure on the footage, video footage involving children/minors, video footage involving interiors of a private residence, or interiors of a healthcare facility/hospital. By leveraging the best-in-class tools from the open source community and elsewhere, advanced file systems, databases, data analytics and machine-based image understanding capabilities may be brought to bear on this problem. AI combination platform 180 primarily enables the administrative and investigative users to quickly and accurately review all of the stored imaging data for evidentiary relevance. AI combination platform 180 also empowers the administrative and investigative users (the End Users) to make quicker decisions relating to the downstream use of this data by other members of the law enforcement community.

In a further embodiment, the digital outdoor media example described below highlights additional benefits of the present approach. Today, the modern outdoor landscape contains numerous sources of real-time data, for example, from the multitude of Internet of Things (TOT) devices, as well as other sources of information, e.g., traffic cameras, etc. Such devices now provide a significant amount of real time data, including real time audio, video, text and other forms of signals. Embodiments of the present approach add value to this situation by taking numerous sources of real-time data and converting it into instant, actionable knowledge for prospective clients. For example, the general public would see a benefit where the actionable knowledge displayed on readily accessible screens. Such screens include digital outdoor advertising screens containing actionable knowledge for the public-at-large, or individual devices (e.g., iPhones) for individualized actionable knowledge for the owner of that individual device. In the case of the digital outdoor advertising screens containing actionable knowledge for the public-at-large, this is the modern day equivalent of the street furniture approach to outdoor advertising made famous by JCDecaux in the twentieth century. JCDecaux made available street furniture (e.g., bus shelters, freestanding informational panels, large-format advertising panels, etc.) at no cost to inner urban areas, where advertising was heavily restricted. In return for the no-cost street furniture, JCDecaux was granted the exclusive right to provide advertising on the provided street furniture. Such an exclusive right gave JCDecaux the opportunity to reach a higher income demographic segment for its advertising.

In the modern twenty-first century analog to JCDecaux's street furniture approach, data from the wide variety of sources is provided as input to a series of algorithmic methods. From these methods are output a wide variety of actionable knowledge such that human interaction with the physical world is significantly advanced. Services that may be provided include: (a) hyper-personal content delivery, (b) hyper-local content delivery, (c) aggregated and automated data insights, and (d) safety and security information. The outcomes provided to customers may also be consolidated and tracked in a similar manner to that of internet cookies such that customer information may be further enhanced. Outcomes and associated content may be published or distributed to several user interfaces that include traditional mobile applications, interactive digital kiosks, virtual reality, deprecated reality, immersion reality, augmented reality, and the like. Outcomes may also be distributed to real-time outdoor advertising exchanges to provide insights into local demographics. National brands, for example, leverage this information to identify what brand to advertise and the value of the potential advertisement.

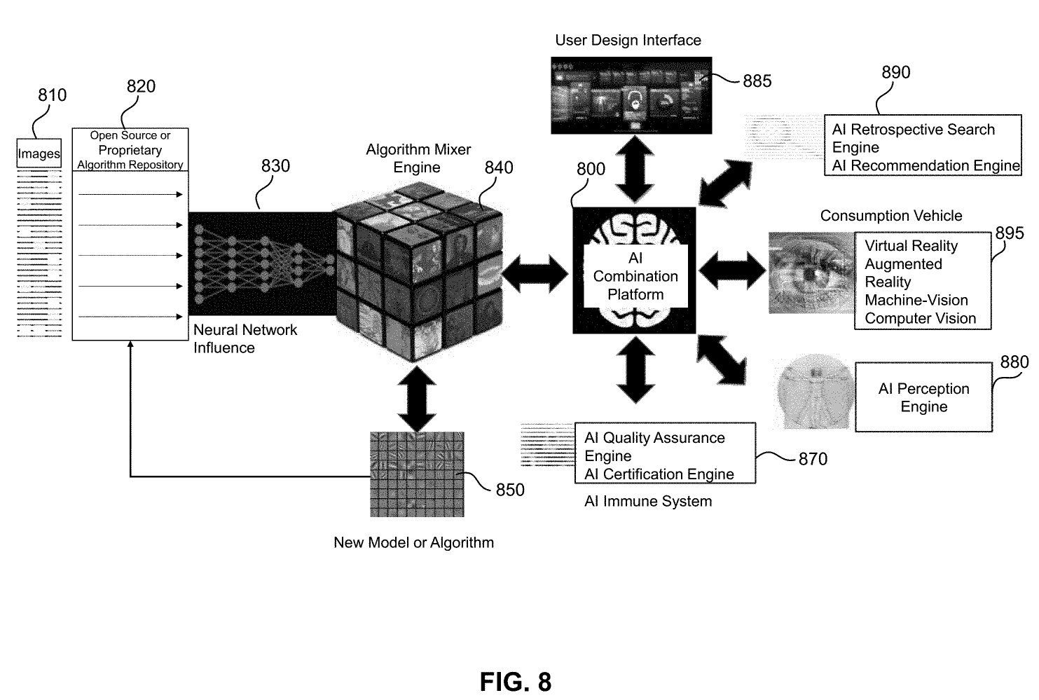

FIG. 8 illustrates an exemplary implementation of the AI combination platform 800. Stored images 810 are provided as input to processing in AI combination platform 800. Input algorithm repositories 820, which may be open source and/or propriety, are passed through optional neural network processing 830 before being input to algorithm mixer engine 840, a part of AI combination platform 800. Algorithm mixer engine 840 produces a new model or algorithm 850, which in turn may be stored in input algorithm repositories 820. Also, AI combination platform includes: (a) user design interface 885 (where a person may visually evaluate the algorithm results), (b) AI retrospective search engine (which, for example, enables coders and non-coders to search functionality of algorithms based on desired outcome) and AI recommendation engine 890 (which provides a recommended algorithm based on the historical choices made by domain experts for particular uses), (c) consumption vehicle 895 that uses the results (e.g., virtual reality, augmented reality, machine vision, computer vision—in an embodiment, these may be set by a human interaction setting), (d) AI perception engine 880, and (e) AI immune system 870, which includes AI quality assurance engine (which, for example, blocks harmful algorithms) and AI certification engine (which, for example, classifies the type of algorithm based on usage). In various aspects of this disclosure, the term Rubix is used as a shorthand for an exemplary AI combination platform.

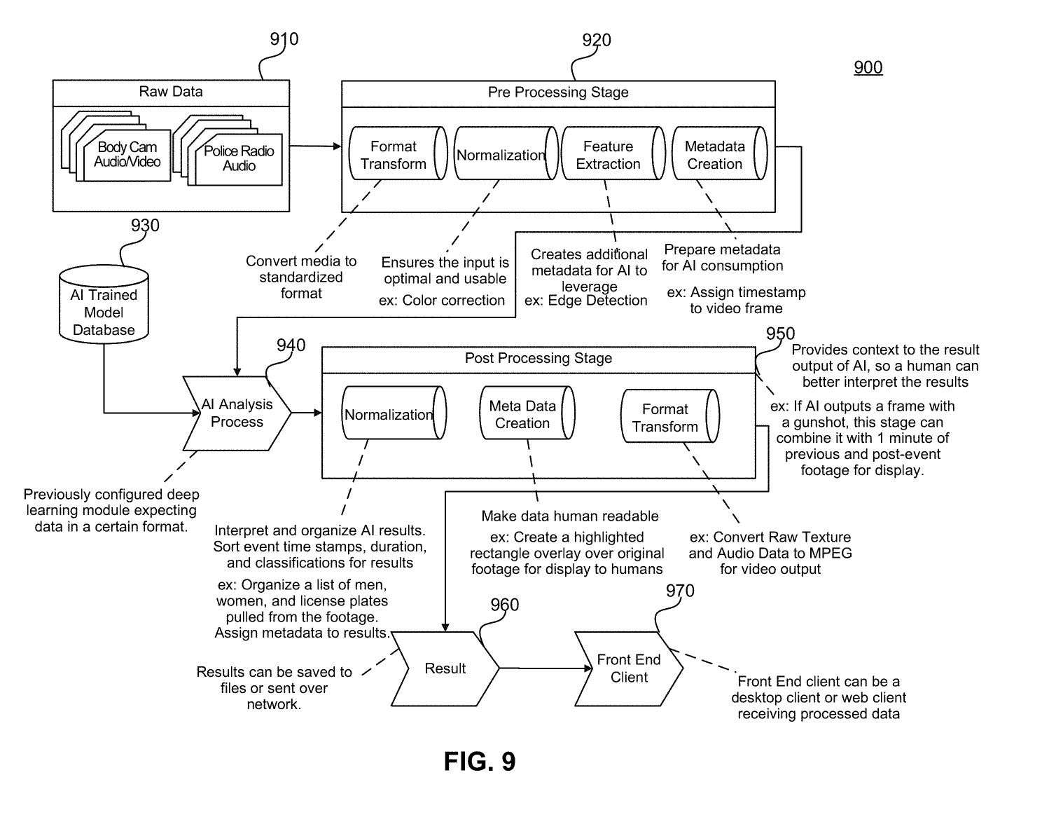

FIG. 9 illustrates a further embodiment of an exemplary work flow, in accordance with embodiments of the present approach. Raw data 910 is input to pre-processing stage 920. In one example, raw data 910 may include body cam audio and/or video from a police officer. Raw data 910 may also include police radio audio. Preprocessing stage 920 processes raw data 910 prior to AI analysis in AI analysis process 940. Preprocessing stage 920 includes one or more of the following: (a) a format transform (e.g., to convert media to a standardized format), (b) normalization (e.g., to ensure that the input is optimal and usable, such as a color correction, (c) feature extraction (e.g., creates additional metadata for AI to leverage, such as edge detection), and (d) metadata creation (e.g., prepare metadata for AI consumption, such as assign a timestamp to a video frame). In addition to AI analysis process 940 receiving the output from preprocessing stage 920, AI analysis process 940 receives trained models from AI trained model database 930. AI analysis process 940 includes, for example, a previously configured deep learning module that expects data in a certain output. Output from AI analysis process 940 is applied to post-processing stage 950. Post-processing stage 950 provides context to the result output of AI analysis process, so a human can better interpret the results. For example, if AI outputs a frame with a gunshot, this stage can combine it with one (1) minute of previous and post-event footage for display. Post-processing stage 950 includes one or more of the following: (a) normalization (e.g., to interpret and organize AI results, such as sorting event time stamps, duration, and classifications for results, for example, organize a list of men, women, and license plates pulled from the footage, assign metadata to results), (b) metadata creation (e.g., make data human readable, such as create a highlighted rectangle overlay over original footage for display to humans), and (c) a format transform (e.g., to convert raw texture and audio data to MPEG for video output). Post-processing stage 950 outputs result 960, which may be saved to files or sent over a network. Finally, result 960 arrives at front end client 970, which may be a desktop client or a web client that receives the processed data.

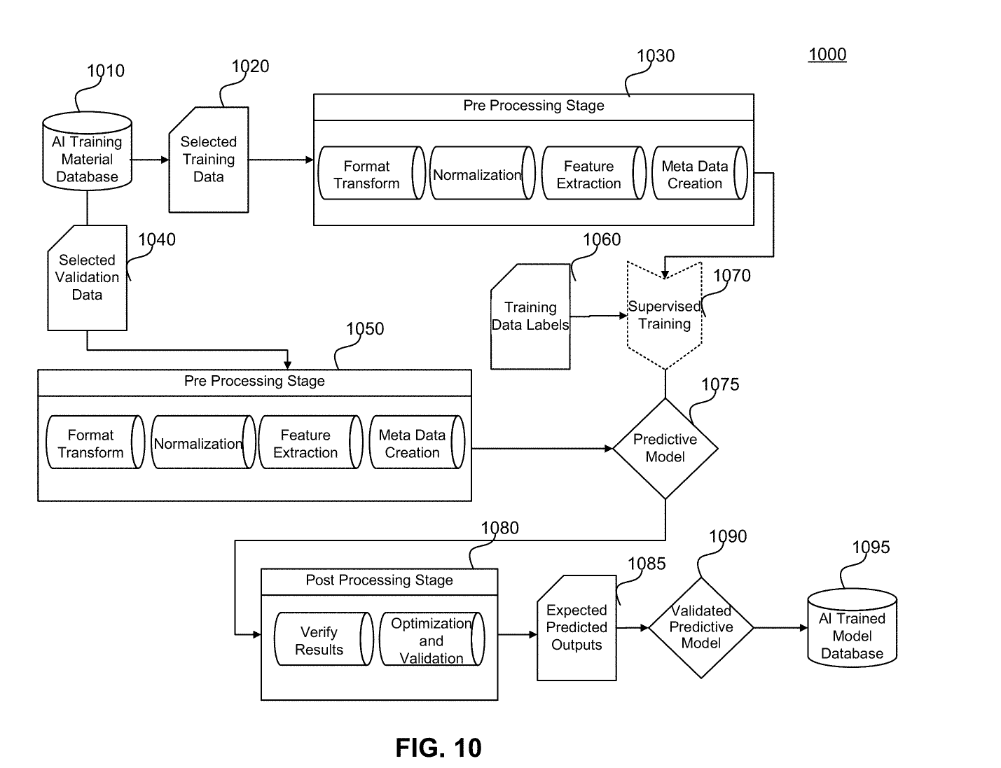

FIG. 10 illustrates a further embodiment of an exemplary work flow, in accordance with embodiments of the present approach. Selected training data 1020 is taken from AI training material database 1010, before being input to pre-processing stage 1030. Preprocessing stage 1030 processes selected training data 1020 prior to supervised training 1070. Preprocessing stage 1030 includes one or more of the following: (a) a format transform (e.g., to convert media to a standardized format), (b) normalization (e.g., to ensure that the input is optimal and usable, such as a color correction, (c) feature extraction (e.g., creates additional metadata for AI to leverage, such as edge detection), and (d) metadata creation (e.g., prepare metadata for AI consumption, such as assign a timestamp to a video frame). In addition to supervised training 1070 receiving the output from preprocessing stage 1030, supervised training 1070 receives input from training data labels 1060. Output from supervised training 1070 provides predictive model 1075, which also receives input from pre-processing stage 1050. Pre-processing stage 1050 provides similar functionality to pre-processing stage 1030, but receives input from selected validation data 1040 from AI training material database 1010. Predictive model 1075 is input to post-processing stage 1080, which includes a results verification, as well as optimization and verification. Output from post-processing stage 1080 is provided to expected predicted outputs 1085, and then validated predictive model 1090 before being stored in AI trained model database 1095.

Further embodiments would be to combine and integrate a computer vision algorithm with acoustic algorithm for sensor-based wearable hardware and applications.

### System Implementation

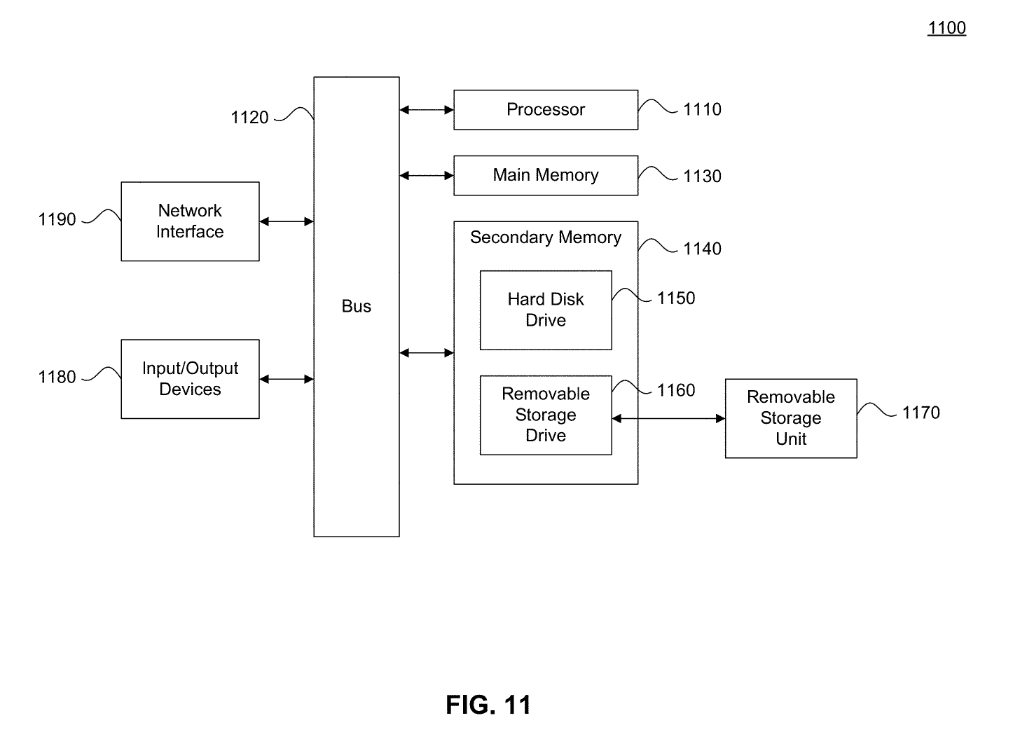

Various aspects of the embodiments can be implemented by software, firmware, hardware, or a combination thereof. FIG. 11 is an example system 1100 (e.g., a computer system) useable to implement embodiments as computer-readable code and/or text-readable code. After reading this description, it will become apparent to a person skilled in the relevant art how to implement the embodiments using other systems and/or processing architectures.

System 1100 includes one or more processors (also called central processing units, or CPUs), such as processor 1110. Processor 1110 is connected to communication bus 1120. System 1100 also includes a main or primary memory 1130, preferably random access memory (RAM). Primary memory 1130 has stored therein control logic (computer software), and data.

System 1100 may also include one or more secondary storage devices 1140. Secondary storage devices 1140 include, for example, hard disk drive 1150 and/or removable storage device or drive 1160. Removable storage drive 1160 represents a floppy disk drive, a magnetic tape drive, a compact disk drive, an optical storage device, tape backup, ZIP drive, JAZZ drive, etc.

Removable storage drive 1160 interacts with removable storage unit 1170. As will be appreciated, removable storage drive 1160 includes a computer usable or readable storage medium having stored therein computer software (control logic) and/or data. Removable storage drive 1160 reads from and/or writes to the removable storage unit 1170 in a well-known manner.

Removable storage unit 1170, also called a program storage device or a computer program product, represents a floppy disk, magnetic tape, compact disk, optical storage disk, ZIP disk, JAZZ disk/tape, or any other computer data storage device. Program storage devices or computer program products also include any device in which computer programs can be stored, such as hard drives, ROM or memory cards, etc.

Embodiments may be directed to computer program products or program storage devices having software that enables system 1100, or multiple system 1100s to perform any combination of the functions described herein.

Computer programs (also called computer control logic) are stored in main memory 1130 and/or the secondary storage devices 1140. Such computer programs, when executed, direct system 1100 to perform the functions of the embodiments as discussed herein. In particular, the computer programs, when executed, enable processor 1110 to perform the functions of the present embodiments including the previous figures, for example. Accordingly, such computer programs represent controllers of system 1100.

System 1100 also includes input/output/display devices 1180, such as monitors, keyboards, pointing devices, etc.

System 1100 further includes a communication or network interface 1190. Network interface 1190 enables system 1100 to communicate with remote devices. For example, network interface 1190 allows system 1100 to communicate over communication networks, such as LANs, WANs, the Internet, etc. Network interface 1190 may interface with remote sites or networks via wired or wireless connections. System 1100 receives data and/or computer programs via network interface 1190.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. An artificial intelligence (AI) combination platform comprising:
a first interface coupled to one or more algorithm repositories; and
one or more processors coupled to the first interface and configured to comprise an algorithm mixer engine, wherein the algorithm mixer engine:
receives via the first interface selected one or more algorithms from the one or more algorithm repositories, the selection based, at least in part, on an identified functionality or outcome of the selected one or more algorithms; and
creates a resulting algorithm based on integration of the selected one or more algorithms, wherein a performance of the resulting algorithm exceeds performances of the selected one or more algorithms based on a performance metric.

2. The AI combination platform of claim 1, wherein the one or more processors are further configured to publish the resulting algorithm for subsequent use.

3. The AI combination platform of claim 1, further comprising:
a second interface coupled to the one or more processors, the second interface configured to receive a human interaction setting; and
a third interface coupled to the one or more processors, the third interface configured to receive a second selection of one or more algorithms via an application programmer interface (API).

4. The AI combination platform of claim 3, wherein the second selection of one or more algorithms via the application programmer interface (API) includes one or more computer vision libraries.

5. The AI combination platform of claim 3, wherein the human interaction setting is one of augmented reality, virtual reality and real virtual reality.

6. The AI combination platform of claim 1, wherein the one or more processors are further configured to comprise a quality assurance engine, wherein the quality assurance engine:
determines whether any of the selected one or more algorithms are harmful based on metadata associated with the selected one or more algorithms; and
blocks one of the selected one or more algorithms based on the determination that the one of the selected one or more algorithms is harmful.

7. The AI combination platform of claim 6, wherein the metadata comprises data reflecting a pedigree of the selected one or more algorithms.

8. The AI combination platform of claim 6, wherein the metadata is encrypted.

9. The AI combination platform of claim 1, wherein the one or more processors are further configured to comprise a certification engine, wherein the certification engine creates a rating one algorithm of the selected one or more algorithms.

10. The AI combination platform of claim 1, wherein the one or more processors are further configured to comprise an algorithm recommendation engine, wherein the algorithm recommendation engine recommends an algorithm from the one or more algorithm repositories to be the selected one or more algorithms, the selection based on input requested functionality and outcome.

11. The AI combination platform of claim 1, wherein the one or more processors are further configured to comprise a perception engine, wherein the perception engine creates perception from both a machine perspective and a human perspective.

12. The AI combination platform of claim 1, wherein the one or more processors are further configured to comprise a retrospective search engine, wherein the retrospective search engine enables coders and non-coders to search functionality of algorithms in the one or more algorithm repositories based on input requested outcome.

13. The AI combination platform of claim 1, wherein the identified functionality of the selected one or more algorithms includes one or more of: motion understanding, egomotion estimation, gesture recognition, 2D and 3D feature toolkits, stereopsis stereo vision, structure from motion, image processing, detection, image association, object tracking, dynamically defined object tracking, fiducials, motion detection, machine learning, machine learning using neural networks, object identification, facial recognition, point cloud and counting of static and moving objects.

14. The AI combination platform of claim 1, wherein the resulting algorithm is approved based on the performance metric.

15. A method comprising:
selecting based, at least in part, on an identified functionality or outcome of one or more algorithms from one or more algorithm repositories;
receiving via a first interface the selected one or more algorithms from the one or more algorithm repositories; and
creating a resulting algorithm based on integration of the selected one or more algorithms, wherein a performance of the resulting algorithm exceeds performances of the selected one or more algorithms based on a performance metric,
wherein the selecting, receiving, and the creating are performed by one or more processors.

16. The method of claim 15, further comprising:
publishing the resulting algorithm for subsequent use.

17. The method of claim 15, further comprising:
determining whether any of the selected one or more algorithms are harmful based on metadata associated with the selected one or more algorithms, and
blocking one of the selected one or more algorithms based on the determination that the one of the selected one or more algorithms is harmful.

18. A tangible computer-readable medium having stored thereon, computer-executable instructions that, if executed by a computing device, perform a method comprising:
selecting based, at least in part, on an identified functionality or outcome of one or more algorithms from one or more algorithm repositories;
receiving via a first interface the selected one or more algorithms from the one or more algorithm repositories; and
creating a resulting algorithm based on integration of the selected one or more algorithms, wherein a performance of the resulting algorithm exceeds performances of the selected one or more algorithms based on a performance metric.

19. The tangible computer-readable medium of claim 18, wherein the method further comprises:
publishing the resulting algorithm for subsequent use.

20. The tangible computer-readable medium of claim 18, wherein the method further comprises:
determining whether any of the selected one or more algorithms are harmful based on metadata associated with the selected one or more algorithms, and
blocking one of the selected one or more algorithms based on the determination that the one of the selected one or more algorithms is harmful.
